(19) United States
(12) Patent Application Publication
(10) Pub. No.: US 2009/0078434 A1
(43) Pub. Date: Mar. 26, 2009

(54) Helicopter supported system for fire fighting including high elevation located fires

(76) Inventor: Mark Archambault, Hollis, NH (US)

Correspondence Address: George W. Dishong, Esq.;DISHONG LAW OFFICES, 40 Bryant Road, Jaffrey, NH, 03452, US

(21) Appl. No.: 12/283,864

(22) Filed: Sep. 16, 2008

Related U.S. Application Data
(60) Provisional application No. 60/994,862, filed on Sep. 21, 2007.

(51) Int. Cl. A62C 3/00; B64D 1/18

(52) U.S. Cl. 169/53; 169/16

(57) ABSTRACT

The invention as disclosed and defined herein, provides for an effective way to fight and subsequently extinguish a fire at a high elevation which is non-reachable for functionally fighting the fire—and which further provides a high quality and a strong helicopter supported system substantially able to carry the material for use in fighting the fire and also provide a means for directively and pressure controllably directing the extinguishing material, most typically water, to the appropriate location for extinguishing the fire. The helicopter supported system of the present invention is the only piece of equipment which is substantially able to carry the material for use in fighting the fire and also provide a means for directively and pressure controllably directing the extinguishing material, most typically water, to the appropriate location for extinguishing the fire. The helicopter supported system and the effective functioning produced by the helicopter supported system of this invention is of significant value to those who need to incorporate an effective and a rapid method to fight a fire especially a fire at an elevation not reachable by the typical fire fighting systems.

### RELATED APPLICATIONS

A provisional application Ser. No. 60/994,862; entitled “A Helicopter Supported System for Fire Fighting Including High Elevation Located Fires” and was filed Sep. 21, 2007, for substantially the invention and for the same inventor as described and now claimed herein.

### GOVERNMENT GRANTS/SUPPORT

None

### BACKGROUND & FIELD OF THE INVENTION & DESCRIPTION OF RELATED ART

Until Applicant hereof invented the invention as disclosed and defined herein, there was no seemingly effective way to fight and subsequently extinguish a fire at a high elevation which is substantially non-reachable for functionally fighting the fire. The helicopter supported system of the present invention is the only, known to the inventor hereof, piece of equipment which is substantially able to carry the material for use in fighting the fire and also provide a means for directively and pressure controllably directing the extinguishing material, most typically water, to the appropriate location for extinguishing the fire. The helicopter supported system and the effective functioning produced by the helicopter supported system of this invention is of significant value to those who need to incorporate an effective and a rapid method to fight a fire especially a fire at an elevation basically not reachable by the typical and well known types of fire fighting systems.

Applicant is now aware of a FIRE FIGHTING SYSTEM disclosed in the Publication No. US 2006/0175429 A1 having a Pub. Date of Aug. 10, 2006. What is disclosed in the ABSTRACT of the Publication is “A firefighting system including a helicopter and a housing defining a receptacle for storing a fire suppressant material removably connectable to the helicopter. At least one cannon connected to the housing where the cannon is automatically extendable from the housing. The helicopter transports the housing to a location of a fire. The cannon is extended from the housing and is operable to emit at least a portion of the fire suppressant material on a fire. The firefighting system may also include a housing sized to transport at least one person trapped by a fire from the building to a safer location.” It is clearly taught that the “cannon” is “automatically extendable from the housing”.

Applicant's high elevation fire fighting system clearly has controllable nozzles in terms of the velocity and the direction of the fire extinguishing material. Further, it is suggested also that the means for controlling the volume and velocity and direction of the material may be controlled from within the helicopter and/or in a safe position relative to and closely associated with the helicopter supported system to transport and effectively deliver to specific locations the controlled extinguishing material. Also included may be a pumping system which provides for the placing into the fluid tank of the material and is submersible in the event the pumped-in fluid is water taken from a pond or lake or other source of water. This pump may well be the same pump creating pressure for the fluid being ejected under control from the nozzles.

### SUMMARY OF THE INVENTION & DETAILED DESCRIPTION OF THE INVENTION

This application describes and discloses substantially an invention—an effective way to fight and subsequently extinguish a fire at a high elevation—and which provides a high quality and a strong helicopter supported system substantially able to carry the material for use in fighting the fire and also provide a means for directively and pressure controllably directing the extinguishing material, most typically water, to the appropriate location for extinguishing the fire. It is within the scope of this invention to incorporate the characteristics and functionality of the helicopter supported system to transport and effectively deliver to specific locations, whether the locations be highly elevated or at substantially ground level, fluid material other than fluid for use in fire fighting such as chemical treatment, covering of clear or color, fluid developed insulation layers, etc. I.e., the invention may be useful in different manners and be incorporated for different purposes than the purpose of only fighting fire at high elevations. The invention is substantially the invention as herein defined.

The fire fighting system may have all or some of the components, sections or elements/features as follows herewith: there is in every form of the invention a transport section which is capable of taking a fluid for use in fire fighting; an attachment section which is capable of removeably attaching a fluid carrying section to the transport section thereby permitting carrying, by the transport section, of the fluid carrying section thereby taking the fluid for use in fire fighting; the fluid carrying section connected by the attachment section to the transport section and there is also provided a means for causing loading of the fluid from a source or supply of the fluid; a nozzle section controllable by a firefighter as to function of the nozzle section by a nozzle control system, the nozzle control system is contained within and a component part of said firefighter housing section and control data and signals are functionally and appropriately connected between the transport section and said firefighter housing section, whereby said nozzle control system is controlled so as to identify direction, volume rate and geomtric shape of outflow of the fluid through a nozzle of the nozzle section.

There may also be incorporated in the fire fighting system a firefighter housing section as a component of the fluid carrying section providing for a firefighter placed therein, a means for controlling pressure and direction of the fluid to be discharged and directed so as to achieve a fire-fighting objective; and there may also be provided a means for loading within a firefighter housing section endangered individuals or materials of significance and which need to be or would be desirable to save from fire destruction.

Additionally there may be provided stands or a leg support section for providing land support for the fluid carrying section reducing potential for damage to the fluid carrying section when in contact with land.

The system may also include more than one nozzle sections so as to enhance the amount and the range of coverage of pressurized fluid onto the fire being fought.

Very generally it is within the scope of this invention that the fire fighting system, provides for a means to cause an effective way to fight and subsequently extinguish a fire at a high elevation—and which provides a high quality and a strong helicopter supported system substantially able to carry the material for use in fighting the fire and also provide a means for directively and pressure controllably directing the extinguishing material, most typically water, to the appropriate location for extinguishing the fire.

It is further within the scope of this invention that the invention, i.e. the fire fighting system is a system to transport and effectively deliver to specific locations, whether the locations be highly elevated or at substantially ground level, fluid material other than fluid for use in fire fighting such as chemical treatment, covering of clear or color, fluid developed insulation layers, etc. I.e., the invention may be useful in different manners and be incorporated for different purposes than the purpose of only fighting fire at high elevations.

It is yet further within the scope of this invention, i.e. the fire fighting system, could be in the form of a simply assembleable unit which requires a relatively simple and quick attachment of the critical components to the helicopter to be used.

It is yet still further within the scope of this invention, i.e. the fire fighting system, could be, in initial form, a kit of components which may be simply and easily assembled for use in fire fighting as needed.

The advantages of the disclosed invention are clearly apparent to those skilled in the art to which the invention and the related inventions herein referenced and it will become apparent to those skilled in the art to which this present invention pertains and after a study of the description of the invention, and the drawings, and the claims.

### BRIEF DESCRIPTION OF THE DRAWINGS

FIG. 1 is a copy of a photograph showing the consequence of a plane crash into a 50-story apartment building overlooking New York's East River and a sketch, for illustrative reasons, of the present invention, the helicopter supported system showing in sketch form the helicopter, the water tanker and the water nozzle with fluid flow eminating from the nozzle toward a building surface;

FIG. 2 is a copy of a photograph showing a polypropylene water tanker, the type of tanker presently preferred as the fluid carrying section and the tank typically and preferably having therein a interior flow control system so as to reduce the rapid flow of fluid from one location to another location within the tank;

FIG. 3 is a sketch showing the substantial four (4) sections: the transport section—preferably a helicopter having the size and power capability to transport the—fluid carrying section and connected or connectable to the transport section by use of the—the attachment section and the nozzle section shown as a component assembly to the fluid carrying section in substantially a bottom and central location of the tanker; and

FIG. 4 is a sketch showing an expansion of the fluid carrying section and the nozzle section which includes a potential location and existence of a fluid pump system, footing for the fluid carrying section, the water tanker and showing the existence of a control line which connects control systems to the tanker from the transport section and to the nozzle and illustrating the existence of a water spray.

### GENERAL FORM OF DISCUSSION OF FIRE FIGHTING

This patent application describes a fire fighting vehicle that will allow a new approach in extinguishing high rise fires and/or forest fires.

In the horror of the Trade Center disaster, it is remembered, a report stating that the first fire fighter at the scene radioed to his commander that “Two lines should be enough to bring this under control.” The fire fighter was referring to two fire hoses. What could have been possible with the CH-54 Skycrane helicopter equipped with a tanker and spray unit? Could it have put enough water to cool the fires down? It was later discovered that the heat from the fires is what triggered the collapse. This effort may not have made a difference to the people trapped on the upper floors, but cooling the fires down may have bought some valuable time.

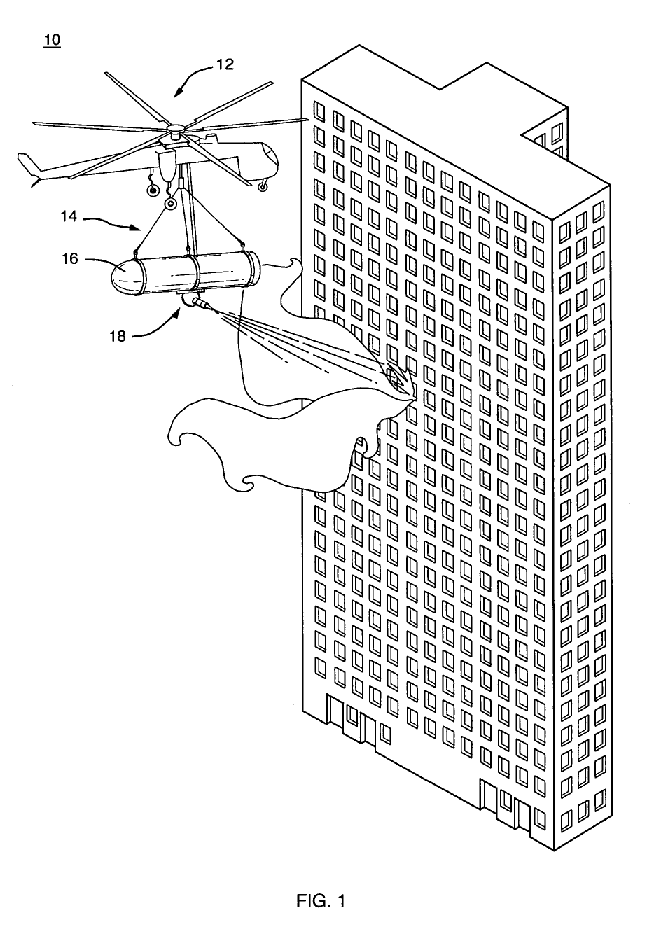

On Oct. 12, 2006 Cory Lidle crashed into a building in Manhattan on the thirty firsts floor. It took the fire fighters over forty five minutes to get to the fire. Using the CH-54 Skycrane with the tanker unit and nozzle could have put water or foam on the fire using the directional spray to its advantage (See FIG. 1).

There are three main components of this invention and a fourth component—a means for attaching the tank to the helicopter is also included additional to the identified components as “three main components”. A first component is the use of a heavy lifting helicopter; a second is a portable water tank that will be filled with either water or a fire retardant material; and a third is a nozzle and pump that can project the material in a variety of sprays using a remote controller.

(A)—The Helicopter;

The helicopter that should be used for the functional use of the invention must be a heavy lifting helicopter. The CH-54 Skycrane or the Chinook helicopter may be used. There is no commitment to any helicopter company thus far so the options are open. There may be heavier lifting helicopters available but for now the Skycrane will be the demonstration vehicle for this project. The Skycrane has a lift capacity of over 47,000 pounds. The weight limit takes into account that the helicopter will be lifting up, down, moving forward, and moving during adverse weather conditions.

The Skycrane does not have the necessary remote control unit for the spray nozzle. Therefore, the remote control unit may be a portable unit that can be carried on the helicopter. Radio signals could control the spray nozzle which would be preferable to allow easy separation between the helicopter and the water tank unit. If it is not possible to use radio controls to maneuver the spray nozzle than it may be possible to have a direct line connecting the controller to the nozzle. The helicopter crew member that controls the crane system can also operate the nozzle with the remote.

(B)—The Water Tank Unit;

The water tank necessary for the functional use of the invention will be an adaptation of water tanks that already exist. Plastic Mart and the U.S. Tanker Corporation are two different companies that make water tanks in a variety of sizes made from Polypropylene. Polypropylene is a special light weight plastic material that would be helpful in keeping the payload light. The lighter the water tank, nozzle unit, and pumping system the more water/fire retardant material can be brought to the fire. Special ballasts are already incorporated in the water tank to keep water from sloshing around but allow the water to travel from one end of the water tank to the other. The water will feed into the pump system until the tank is empty. Metal containers, including aluminum, may also be considered due to their durability. It may be possible to used compressed air to create the force to push the water.

Water Tank Adaptations;

The water tank would have to be able to be suspendable from the Skycrane via a cable. A ground crew will need to connect and disconnect the water tank from the Skycrane cable system. This means some sort of harness would have to be attached to the structure of the water tank unit. Once the tank is empty the ground crew can disconnect the empty tank and reconnect the cable to a second tank; prefilled. While the helicopter takes off to return to the fire, the empty tank can be refilled by the ground crew. The opening at the top of the water tank, already installed, would be utilized to fill the water tank manually. A latter will have to be included on the outside of the water tank in order to allow ground crew access to the top of the water tank. Plastic-mart includes the option of a latter with the purchase of the larger tanks. This tank will be adaptable to use other fire retardant materials as well as water.

Other Refill Method;

The water tanker unit would also need to have the ability to submerge in a lake, swamp, sea, or pool for refilling. In order for the water tank to fill itself in such a manner, a special “trap door” system could be integrated at the bottom of the water tank. Opening and shutting these “trap doors” would have to be controlled from the helicopter by remote control or louver doors that open and close by water pressure could be installed. The advantage of this type of reloading is that there is no ground crew needed and the helicopter could refill in remote areas where a ground crew would be unavailable.

Water Tank Concerns;

By using the water tanker/flooding technique as described above, a flotation device may need to be attached to the top of the water tank in order to keep the water tank from sinking. It is ideal for the water tank to sink level with the surface of the water but not any further due to the fact that the water tank sinking any further would pull the Skycrane down. Most helicopters refill by dipping the harness system without any floatation devise however the larger size of the tank may require the floatation device.

The air release opening at the top of the water tank may need to be increased to allow fast sinking. The quicker the air escapes, the quicker the water tank will refill, the sooner the helicopter is back at the fire. This air release opening may also be used when filling by hose manually (as described above).

There is the concern that the water may be polluted with object or material that would hamper the “trap doors” from closing and potentially clog the nozzle apparatus. Special screening may need to be improvised in order to prevent clogging problems. How fire trucks fill their water tanks with pond water may provide a solution to these water screening problems.

There is also a pump system made by Fast Flow manufacturing that uses a reversible submergible pump that can push 1000 gallons/per minute. Not only could this pump be used to create the pressure for the fire nozzle, but it may be used to refill the submerged tank.

Since the water tank is made of a plastic material, the high temperature of a fire may be cause for concern. In order to know how much heat the Polypropylene water tank can take, melting point information from the manufacturer will need to be acquired. Special heat sensors may be added to the outside of the water tank that may send a signal to Skycrane crew to warn of any high temperatures to prevent any damage to the water tank or nozzle units.

The length of the cable that attaches the Skycrane to the water tanker unit may have an effect on vibration from weather conditions. It is expected that the longer the cable the better in order to absorb vibration, and also keep the rotor wash from dispersing the water spray. Two cables would be necessary in order to keep the tank from spinning. Spinning pressures will be cause by the pressure of the nozzle at the scene of the fire. These cause and effects situations along with different weather conditions would have to observed and adjusted will have to be made with simulation testing.

(C)—The Nozzle and Pump Unit;

The nozzle and pump unit will be similar to the ones currently used on hook and latter fire trucks. The nozzle and pump unit will be connected to the end of the water tank and will have the ability to spray in several directions, with a variety of pressures. Mounting the nozzle at the end of the water tank may allow better vision for the operating pilot. The size of the spray nozzle and its pump will be determined by the weight and the distance the water can be sprayed. Crew safety is the most important goal. Keeping the water tank and nozzle unit away from the damaging heat is the secondary concern. This nozzle will need to target a fire under adverse weather conditions including heavy updrafts. The further the distance the water can travel the better. It may even be advantageous to have two nozzles dispersing the water to increase the volume of spray. These nozzles will also be adaptable to use fire retardant material as well as water.

### DETAILED DESCRIPTION OF THE INVENTION

This application describes and discloses substantially an invention—an effective way to fight and subsequently extinguish a fire at a high elevation—and which provides a high quality and a strong helicopter supported system substantially able to carry the material for use in fighting the fire and also provide a means for directively and pressure controllably directing the extinguishing material, most typically water, to the appropriate location for extinguishing the fire. It is within the scope of this invention to incorporate the characteristics and functionality of the helicopter supported system to transport and effectively deliver to specific locations, whether the locations be highly elevated or at substantially ground level, fluid material other than fluid for use in fire fighting such as chemical treatment, covering of clear or color, fluid developed insulation layers, etc. I.e.; the invention may be useful in different manners and be incorporated for different purposes than the purpose of only fighting fire at high elevations.

The invented system 10 and components of the system is basically a simple system and apparatus having substantially four (4) sections:

1. A transport section 12 (most generally a helicopter) which is capable of taking the fluid for use in fire fighting and from within the transport section there is provided a means for causing the fluid to be discharged and directed so as to achieve the fire-fighting objective;
2. An attachment section 14 which is capable of being removeably attachable from the transport section to a fluid carrying section thereby permitting the flight-carrying by the transport section of the fluid carrying section thereby taking the fluid for us in fire fighting;
3. The fluid carrying section 16 connected by the attachment section to the transport section and from within the transport section there is provided a means for causing the fluid to be discharged and directed so as to achieve the fire-fighting objective and means for causing the loading of fire fighting fluid—generally water—from a source or supply of fluid; and
4. A nozzle section 18 controllable as to function of the nozzle section by a nozzle control system, preferably the nozzled control system is contained within and a component part of the transport section 12 and the control data or signals are connected appropriately between the transport section and the fluid carrying section, whereby the nozzle control system can be controlled so as to direct the direction, the volume rate and the geometric shape of the outflow of fluid.

This document describes the plan to use the CH-54 Skycrane helicopter 12 along with a specialized water tank 16 and fire nozzle section 18 as a fire fighting system 10. It is clearly noted that helicopters other than the CH-54 Skycrane may be incorporated for use with this invention provided for proper change in the size, weight, form of structure of the fluid carrying system, the location of the area of deposit or spraying of the fluid. The system of the invention 10 is adaptable so as to be functional with different helicopters.

The objectives and goals of this invention and plan are as follows: To increase the helicopter water capacity for each drop; To increase the time the vehicle stays over a target area; To use a remote control spray nozzle to allow accurate water targeting; To decrease the time in reloading the water tanker unit; and To increase safety for the pilots and crews of the air vehicles.

The current state of the art for the components/elements of the system are such that they are available now for use in the system:

Currently, helicopters are typically used to fight forest fires by carrying a bucket that hangs from the helicopter by a cable. The carrying bucket can be refilled by being submerged into a lake, pool, or ocean. The bucket may also be filled by a fire crew on the ground using water from a fire hydrant or a ground driven tanker. When the bucket is filled, the helicopter positions itself over the fire and drops its payload in an attempt to extinguish the flames. This process is continued as often as needed. The benefit of this procedure is that the helicopter can reach remote areas quickly with a certain degree of safety.

Downfalls of this procedure are that the helicopters can only carry small amounts of water due to the excessive weight. The Bell 212 helicopter which leases for over two million a year, can carry a payload of only 4,000 pounds. Filling buckets can be difficult if the sources of water are not deep enough to fill the buckets or are too far away from the fire. Filling buckets using ground crews can be very time consuming and difficult to manage in areas without roads. In one example during the post Katrina disaster, a house caught on fire surrounded by flood water. The helicopter had to retreat to the ocean, over three miles away, in order to refill the bucket. The water in the streets was deep enough to keep fire trucks from reaching the scene. The house was lost.

Another problem with helicopters dropping water on a fire is the inaccuracy. For example, high winds go hand in hand with forest fires. Water can be blown away from its target rendering the effort useless. High winds and updrafts also increase the danger for pilots trying to control the vehicle.

Similar problems occur with planes loaded with water or fire retardant materials. In California a large plane was being used to drop a fire retarded material over a hot spot. During the drop an updraft broke one of the wings completely off of the plane causing it to crash within a few seconds. The crew did not have the time to save themselves due to the low altitude necessary for an accurate drop. None of the crew survived.

It is considered very reasonably possible to avoid at least some of the disasters by combining a helicopter such as the CH-54 Skycrane and several firefighting apparatus that already exist today.

### The Tanker:

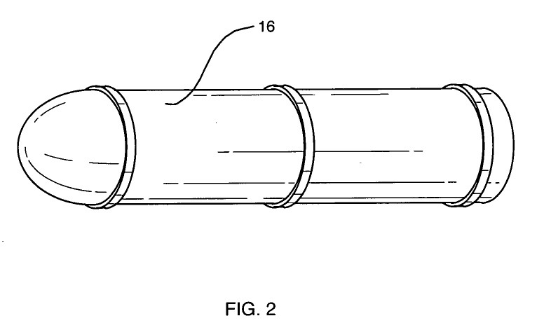

U.S. Tanker Fire Apparatus Inc. has a variety of tanks made of Polypropylene that can hold up to a maximum of 40,000.00 gallons of water. (See FIG. 2). The tanks are made of a durable material that is light and strong and are the top choice when it comes to fire truck manufacturers due to the cost and performance. The tanks are constructed with dividers part of 16 built inside the tank 16 to reduce water sloshing which is a feature of real benefit for the helicopter transporting the tank.

### The Sikorsky CH-54 Skycrane Helicopter:

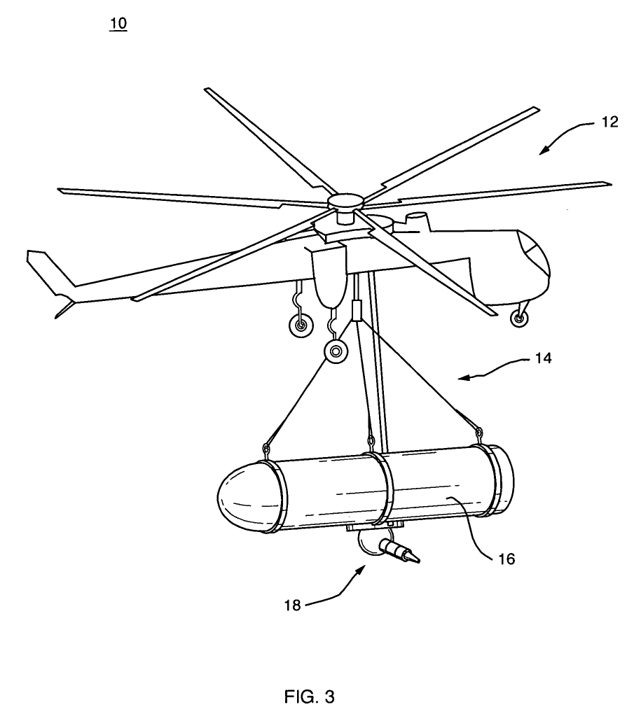

The CH-54 Skycrane Helicopter is a large capacity vehicle used by the Army typically used to move supplies or troops from one place to another. The load capacity of the Skycrane is over 47,000 lbs. The Skycrane can reach speeds of over 100 miles/hr and has a range of 230 miles. (See FIGS. 1 and 3). Although the Skycrane has been used in fire fighting applications in the past, it has only utilized water pumping capability from the same hydraulic system that drives helicopter engines. Currently, the Skycrane does not have the necessary power needed to pump with an effective water nozzle. The invention 10 of Applicant herein, clearly teaches the need for a power pump 18A of nozzle section 18 which has included pump 18A and nozzle 18B.

### The Nozzle:

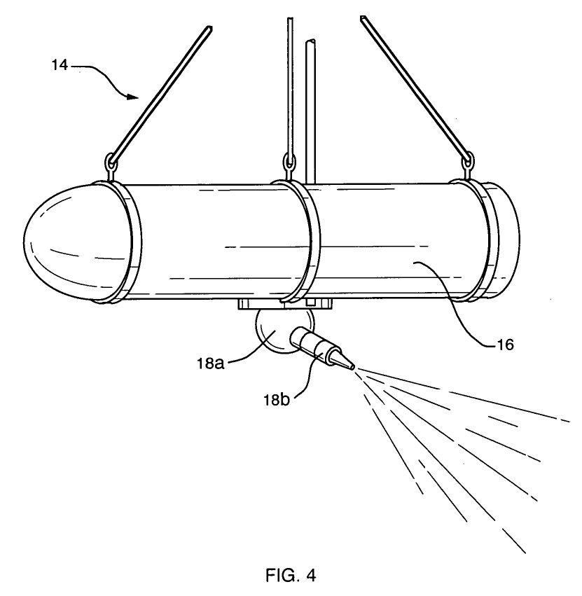

Specialized spray nozzles are available that allow firemen to control targeting fires from the inside of the fire truck. This spray nozzle 18B has different types of spray velocities depending on the need. Sometimes it is necessary to use a direct water stream on a target for power and sometimes it is beneficial to use a wider fan type spray to cover more area. (See FIG. 4). This nozzle has been used while fire trucks are moving from one location to another when flames are consuming the terrain in front of the vehicle. Grass fires are a target for the wider spray nozzle because the truck is moving while extinguishing the row of flames. The nozzle is piloted by a controller that sits inside of the truck unexposed to the smoke, heat, and flames.

In Japan, similar nozzles have been attached to helicopters that can spray horizontally into the side of a Skyscraper. The effort helps but is limited because of the small amounts of water each helicopter can carry. In this particular example the helicopter can only spend up to two minutes over the target before reloading not to mention the limits of the small spray nozzle. Large capacity spray nozzles are used in tug boats that can pump hundreds of gallons of water in less than a minute. These fire tug boats pump water from the ocean using very large diesel engines. The range of these fire nozzles can reach distances longer than a football field. The system of applicant's invention clearly teaches the use and effectiveness of a proper nozzle and pump system.

### A Different Approach:

The present plan and the most desirable system presently will preferably use the Skycrane to carry a specialized spray nozzle attached to the bottom of the water tanker unit. (See FIGS. 1, 3 and 4). The size of the water tanker unit will depend on the lift capabilities of the CH-54 Skycrane. The Skycrane lifting payload of 47,000 pounds compared to the Bell 212 helicopters 4,000 pounds shows a variable of room to improve the size of the water load. The weight of the spray nozzle and its own pump, separate from the Skycrane engines, will need to be included in the payload. The water tanker unit will feed the spray nozzle. The direction and type of spray will be controlled by a pilot in the CH-54 Skycrane which will be separate from the pilot flying the Skycrane. A ground crew will be necessary to connect the tanker and spray nozzle unit to the Skycrane cable system while the helicopter is in flight.

When the water tank empties, the helicopter will have several options to reload. The first option is to place the tanker unit and the nozzle on the ground at a base location. The ground crew must unhook the empty tanker unit from the Helicopter then hook the next loaded tanker unit while the helicopter is still in flight. While the empty unit is being filled again by the ground crew, the helicopter can continue the assault on the fire with little layover time. (For this operation to work there needs to be at least two tankers complete with their own spray nozzles.)

The spray nozzle controls will need to be disconnected and reconnected as the tankers are dropped and picked up. The tanker unit would need to include feet that would extend past the spray nozzle in order to keep it from being crushed when placed on the ground. Two empty water tanks and the nozzle units could be carried to a fire base by the Skycrane where they would be loaded for use.

It may also be possible for the Skycrane to drop the water tanker into a lake to reload. If special doors could open on the water tanker once placed on the surface of the water the tanker would fill on its own. The tanker would sink like a submarine reloading for the next drop without a ground crew. This procedure has not been tested and will need to be experimented with but not for the present application for this invention. The main concern with reloading by submerging the tanker is that the water nozzle and pump would need to be protected from water contamination. The water tanker would also need to have some sort of air pocket at the top to keep it from sinking.

### Other Concerns:

Fire storm winds usually accompany forest fires. Trying to control the Skycrane with a loaded water tanker may be difficult. Operating under these conditions would also have to be tested. The success or failure of controlling the Skycrane during high winds may rely on the power of the turbine engines, the pilot, and the power of the six rotors.

The power of the rotor wash may create a difficult environment for the ground crew switching water tanks. Current loading and unloading procedures will need to be observed to know what can and cannot be done. A remote control line must be connected between the Skycrane and the water tank nozzle unit each time a tank is switched over. The length of the cables between the Skycrane and the tanks will have a direct effect on the transfer as well as where the connection is made. The Skycrane may have to lower a cable to pick up the cable setup as well as the remote control line.

The reliability of these types of tanks in a “close to fire” environment would need to be tested. Adding heat sensors to the bottom of the tank may help warn pilots that they are flying too close to the fire. It is expected the tanker to hang from an extended cable system rather than trying to fit the tank in the body of the Skycrane. The cables should help absorb some of the water sloshing as well as vibrations from other weather conditions.

There is also the possibility that the force created by the pressure of the nozzle may cause control problems. Depending on the direction the nozzle is aimed, the spray nozzle would naturally want to push the entire tanker unit away from the target. These natural forces will vary depending on the type of spray the pilot desires to use, the wind conditions, and could change dramatically as the water flow to the unit increases or degreases. The good news is that the Skycrane engines are noted as the most powerful helicopter engines currently available but similar engines should also be available presently or in the near future given the apparent need to have such a system as disclosed by the inventor hereof.

### IN CONCLUSION

The elements specified herein and needed for the proper functioning of the system, from a technology viewpoint already exits. The need for the availability and timely use of the system is apparent. It is clearly envisioned by the inventor hereof, that proper helicopters equipped with the appropriate tanks and nozzles will be placed in cities around the United States and the rest of the world. It is no doubt that fire related accidents and disasters will continue to plague the planet. It is believed that the use of the disclosed system of the inventor will help to reduce such plague.

The fire fighting system 10 is a system to transport and effectively deliver to specific locations, whether the locations be highly elevated or at substantially ground level, fluid material other than fluid for use in fire fighting such as chemical treatment, covering of clear or color, fluid developed insulation layers, etc. I.e., the invention may be useful in different manners and be incorporated for different purposes than the purpose of only fighting fire at high elevations.

The fire fighting system, could be in the form of a simply assembleable unit which requires a relatively simple and quick attachment of the critical components to the helicopter to be used.

The fire fighting system, could be, in initial form, a kit of components which may be simply and easily assembled for use in fire fighting as needed.

The advantages of the disclosed invention are clearly apparent to those skilled in the art to which the invention and the related inventions herein referenced. It will become apparent to those skilled in the art to which this present invention pertains and after a study of the description of the invention, and the drawings, and the claims, which claims will be included in a subsequent and timely filed Utility patent application, many variations of the material of the elements used and the manner and the location of use of the elements within and becoming a part of the items.

What I claim is:

1. A fire fighting system comprising:
a transport section which is capable of taking a fluid for use in fire fighting;
an attachment section which is capable of removeably attaching a fluid carrying section to said transport section thereby permitting carrying, by said transport section, of said fluid carrying section thereby taking said fluid for use in fire fighting;
said fluid carrying section connected by said attachment section to said transport section and means for causing loading of said fluid from a source or supply of said fluid; and
a nozzle section controllable as to function of said nozzle section by a nozzle control system, said nozzle control system is contained within and a component part of said transport section and control data and signals are functionally and appropriately connected between said transport section and said fluid carrying section, whereby said nozzle control system is controlled so as to identify direction, volume rate and geomtric shape of outflow of said fluid through a nozzle of said nozzle section.

2. The fire fighting system according to claim 1 wherein said transport section is a helicopter having capability to flight-carry said fluid carrying section having said fluid therein and said nozzle section attached thereto.

3. The fire fighting system according to claim 1 further comprising a means for controlling pressure and direction of said fluid to be discharged and directed so as to achieve a fire-fighting objective, said means for controlling pressure and direction within said transport section.

4. The fire fighting system according to claim 2 wherein said helicopter further comprising a means for controlling pressure and direction of said fluid to be discharged and directed so as to achieve a fire-fighting objective from said nozzle section, most typically water, to appropriate location for extinguishing a fire.

5. The fire fighting system according to claim 1 further comprising a means for providing land support for said fluid carrying section reducing potential for damage to said fluid carrying section when in contact with land.

6. The fire fighting system according to claim 2 further comprising a means for providing land support for said fluid carrying section reducing potential for damage to said fluid carrying section when in contact with land.

7. The fire fighting system according to claim 3 further comprising a means for providing land support for said fluid carrying section reducing potential for damage to said fluid carrying section when in contact with land.

8. The fire fighting system according to claim 4 further comprising a means for providing land support for said fluid carrying section reducing potential for damage to said fluid carrying section when in contact with land.

9. A fire fighting system comprising:
a transport section which is capable of taking a fluid for use in fire fighting;
an attachment section which is capable of removeably attaching a fluid carrying section to said transport section thereby permitting carrying, by said transport section, of said fluid carrying section thereby taking said fluid for use in fire fighting;
said fluid carrying section connected by said attachment section to said transport section and means for causing loading of said fluid from a source or supply of said fluid;
a firefighter housing section as a component of said fluid carrying section providing for a firefighter placed therein, a means for controlling pressure and direction of said fluid to be discharged and directed so as to achieve a fire-fighting objective; and
a nozzle section controllable by said firefighter as to function of said nozzle section by a nozzle control system, said nozzle control system is contained within and a component part of said firefighter housing section and control data and signals are functionally and appropriately connected between said transport section and said firefighter housing section, whereby said nozzle control system is controlled so as to identify direction, volume rate and geomtric shape of outflow of said fluid through a nozzle of said nozzle section.

10. The fire fighting system according to claim 9 wherein said transport section is a helicopter having capability to flight-carry said fluid carrying section having said fluid therein and said nozzle section attached thereto.

11. The fire fighting system according to claim 9 further comprising a means for loading within said firefighter housing section endangered individuals or materials of significance.

12. The fire fighting system according to claim 10 further comprising a means for loading within said firefighter housing section endangered individuals or materials of significance.

13. The fire fighting system according to claim 9 further comprising a means for providing land support for said fluid carrying section reducing potential for damage to said fluid carrying section when in contact with land.

14. The fire fighting system according to claim 10 further comprising a means for providing land support for said fluid carrying section reducing potential for damage to said fluid carrying section when in contact with land.

15. The fire fighting system according to claim 11 further comprising a means for providing land support for said fluid carrying section reducing potential for damage to said fluid carrying section when in contact with land.

16. The fire fighting system according to claim 12 further comprising a means for providing land support for said fluid carrying section reducing potential for damage to said fluid carrying section when in contact with land.

17. The fire fighting system according to claim 9 wherein said fluid carrying section further comprises at least one additional nozzle section controllable by said firefighter.

18. The fire fighting system according to claim 10 wherein said fluid carrying section further comprises at least one additional nozzle section controllable by said firefighter.

19. The fire fighting system according to claim 12 wherein said fluid carrying section further comprises at least one additional nozzle section controllable by said firefighter.

20. The fire fighting system according to claim 16 wherein said fluid carrying section further comprises at least one additional nozzle section controllable by said firefighter.
